(19) United States
(12) Patent Application Publication
(10) Pub. No.: US 2011/0142354 A1
(43) Pub. Date: Jun. 16, 2011

(54) APPARATUS AND METHOD FOR DETECTING POSE IN MOTION CAPTURE DATA

(75) Inventors: Man Kyu SUNG, Daejeon (KR); Myunggyu KIM, Daejeon (KR); Sang Won GHYME, Daejeon (KR); Sung June CHANG, Daejeon (KR); Il-Kwon JEONG, Daejeon (KR); Byoung Tae CHOI, Daejeon (KR)

(73) Assignee: Electronics and Telecommunications Research Institute, Daejeon (KR)

(21) Appl. No.: 12/787,098

(22) Filed: May 25, 2010

(30) Foreign Application Priority Data
Dec. 11, 2009 (KR) 10-2009-0123342

(51) Int. Cl. G06K 9/62

(52) U.S. Cl. 382/209

(57) ABSTRACT

An apparatus for detecting a pose in motion capture data includes: a motion data input unit which receives motion data of characters; a virtual marker attaching unit for forming a point cloud by attaching virtual markers to joints of an end-effector of each character; and a scaling unit for, when a frame has different character size from an a character size of an original frame to be compared is detected, scaling the character size. The apparatus further includes an ICP algorithm execution unit for finding a matching transformation matrix between the original frame and each frame of the motion data, of which character size has been scaled, by applying an ICP algorithm, and determining a frame, in which character's pose has the smallest difference from that in the original frame based on a sum of the distances between the virtual markers chosen by sampling the matched two poses.

### CROSS-REFERENCE(S) TO RELATED APPLICATION

The present invention claims priority of Korean Patent Application No. 10-2009-0123342, filed on Dec. 11, 2009, which is incorporated herein by reference.

### FIELD OF THE INVENTION

The present invention relates to a technique of detecting a similar pose in a frame of motion capture data to an original frame to be compared, and more particularly, to an apparatus and method for detecting a pose in motion capture data, which are suitable for performing the function of finding a similar pose even in motion capture data having joints at which the size of a character is different or not exactly the same to a pose in an original frame to be compared.

### BACKGROUND OF THE INVENTION

The format of motion capture data widely used for computer animation is divided into a portion defining a skeletal structure and a motion data portion for assigning a joint angle value for each frame of the defined skeletal structure. The shape of the skeletal structure, although somewhat different depending on file format, is defined by a joint name, an offset value, a three-dimensional (3D) position vector of the root joint, and an Euler angle value on the basis of a BVH file format which is extensively used. The skeletal structure defining portion is represented, for example, by the following Table 1:

TABLE 1

HIERARCHY
ROOT Hips
{

OFFSET 0 0 0
CHANNELS 6 Xposition Yposition Zposition

Zrotation Xrotation Yrotation

JOINT RightHip
{

OFFSET 1.04832e−005 4.34048e−006 0
CHANNELS 3 Zrotation Xrotation

Yrotation

JOINT RightUpLeg

...

Meanwhile, the offset value is a 3D vector representing the size and direction of a joint in local coordinates. Every other joint, except for the root joint, has only an angle value. The Xposition, Yposition, and Zposition of the 3D root joint represent the global position of the character.

A pose of the character captured by motion capture can be represented by the poses of the limbs, spine, and neck of any specific frame (time). Since various motions required for game, etc. cannot be captured in one sequence at a time, they are captured in parts multiple times, and the operation of putting such multiple motion capture clips together is performed. Further, in order to create a looping motion using captured data or for smooth and quick motion conversion by keyboard input which is used often in games, the operation of finding a similar pose in motion capture data should be basically performed.

The simplest method of finding a similar pose in a motion capture is to check each frame one by one with eyes and compare the poses by manual work. However, if a frame is long, it takes a lot of time and there is a high possibility that human visual judgment may be misleading.

Therefore, in order to automate this method, there was devised a method which represents the pose of a character by one vector and calculates a mathematical distance between this vector and a vector corresponding to the pose of another frame to automatically calculate a frame having the smallest difference. A pose vector of an i-th frame can be represented by M(i) as follows:

M(i)=(p₁(i),qᵢ(i), . . . , qₘ(i)) Eq. 1

wherein P₁(i) is the global 3D position coordinates of the root joint, q₁(i) is the global 3D rotation of the root joint, and qₘ(i) is the local 3D Arotation of an m-th joint. A difference D(i;j) between M(i) and M(j) can be calculated by the following Eq. 2:

D(i,j)=({square root over ((p₁(i)−p₁(j))},q₁(i)⁻¹q₁(j),q₂(i)⁻¹q₂(j), . . . , qₘ(i)⁻¹qₘ(j)) Eq. 2

However, this method does not reflect the characteristics of a joint angle. That is, each joint has a different effect on the entire poses (i.e., the difference between hip joint values has a bigger effect on the poses than the difference between ankle joint values has), so the difference between joint angles alone cannot determine a pose difference.

In addition, even though the same person is motion-captured, if he or she has a different hierarchical skeletal structure from that of captured data, comparison of poses cannot be performed by the joint angle values alone because almost all motion capture data formats are in the form of local coordinates and an offset vector representing the direction and length of a joint on the local coordinates has a different coordinate system. That is, even the same angle value may represent totally different poses.

To overcome this problem, there has been employed a point cloud method, that is, a method of calculating the global coordinates of 3D virtual markers (points) and comparing two poses under the assumption that the 3D markers (points) are attached to the skeletal structure of a character. This method is a method which calculates a transformation matrix for optimally matching point clouds, which are a set of virtual markers of two poses to be compared, by using an optimization technique, transforms one point cloud using this transformation matrix, and calculates the minimum distance between respective points to calculate the distance between the two poses. This method was devised based on the idea of making it easier for people to discriminate the poses of a character by using meshes corresponding to the skin, rather than the skeleton of the character.

Among the methods of finding a similar pose according to the prior art which operate as above, the point cloud method has a problem that it is difficult to find a correct transformation matrix because all the points in the point clouds of two poses have to correspond one-to-one to each other and, even if the two poses are logically exactly the same, the position of a 3D marker differs depending on size.

### SUMMARY OF THE INVENTION

The present invention provides an apparatus and method for detecting a similar pose in motion capture data, which can automatically find a frame having a similar pose by analyzing motion capture data for character animation.

The present invention further provides an apparatus and method for detecting a similar pose in motion capture data, which can find a similar pose even in motion capture data having joints at which the size of a character is different or not exactly the same.

In accordance with a first aspect of the present invention, there is provided an apparatus for detecting a pose in motion capture data.

The apparatus includes: a motion data input unit which receives a plurality of motion data of characters; a virtual marker attaching unit for forming a point cloud by attaching virtual markers to joints of an end-effector of each character in a frame of the motion capture data; a scaling unit for, when a frame/frames has/have different character size from an a character size of an original frame to be compared is detected, scaling the character size; and an iterated closest point (ICP) algorithm execution unit for finding a matching transformation matrix between the original frame and each frame of the motion data, of which character size has been scaled, by applying an ICP algorithm, and determining a frame, in which character's pose has the smallest difference from that in the original frame based on a sum of the distances between the virtual markers chosen by sampling the matched two poses.

In accordance with a second aspect of the present invention, there is provided a method for detecting a pose in motion capture data. The method includes: receiving a plurality of motion data of characters; forming a point cloud by attaching virtual markers to joints of an end-effector of each character in a frame of the motion capture data and; finding a matching transformation matrix between the original frame and each frame of the motion data, of which character size has been scaled, by applying an iterated closest point (ICP) algorithm, and determining a frame, in which character size having the smallest difference from an the original frame based on a sum of the distances between the virtual markers chosen by sampling the matched two poses.

### BRIEF DESCRIPTION OF THE DRAWINGS

The objects and features of the present invention will become apparent from the following description of embodiments, given in conjunction with the accompanying drawings, in which:

FIG. 1 is a block diagram illustrating a configuration of a pose detection apparatus in accordance with an embodiment of the present invention;

FIG. 2 is a flowchart illustrating an operating procedure of the pose detection apparatus in accordance with the embodiment of the present invention;

FIG. 3 is a view illustrating a virtual marker attaching method in accordance with the embodiment of the present invention;

FIG. 4 is a view defining a center point and a character size in accordance with the embodiment of the present invention;

FIG. 5 is a view illustrating a method for scaling the size of a character in accordance with the embodiment of the present invention;

FIG. 6 is a flowchart illustrating an operating procedure of an ICP algorithm in accordance with the embodiment of the present invention;

FIG. 7 is a view illustrating character segments in accordance with the embodiment of the present invention; and

FIG. 8 is a view illustrating an ICP point matching method in accordance with the embodiment of the present invention.

### DETAILED DESCRIPTION OF THE EMBODIMENTS

Hereinafter, the operational principle of the present invention will be described in detail with reference to the accompanying drawings which form a part hereof.

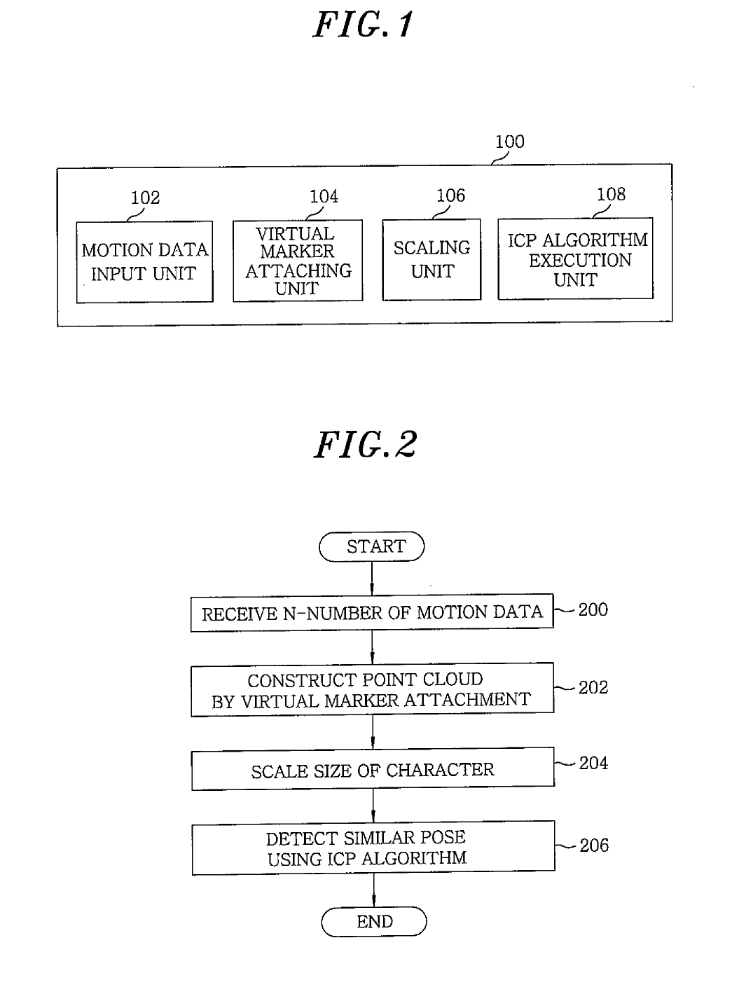

FIG. 1 is a block diagram showing a configuration of a pose detection apparatus in accordance with an embodiment of the present invention.

Referring to FIG. 1, the pose detection apparatus 100, which is included in a computer or implemented by a computer, includes a motion data input unit 102, a virtual marker attaching unit 104, a scaling unit 106, and an iterated closest point (ICP) algorithm execution unit 108.

Specifically, the motion data input unit 102 receives an n-number of motion data for finding a similar pose. The n-number of data may have different character sizes. But, characters of the n-number of data need to be of a character of conceptually the same kind, because four-legged animal and human are of a different species, so it is difficult to find similar motions thereof.

A format of motion capture data is divided into a portion defining a skeletal structure and a portion for assigning a joint angle value for each frame of the skeletal structure. Accordingly, the virtual marker attaching unit 104 calculates 3D global coordinates of a joint for each frame in order to make virtual marker implementation easier and regards that a virtual marker is attached to this position.

That is, if a skeleton having m frames and k joints is defined in one input motion, k virtual markers can be attached logically. However, a main factor of determining the pose of a character is a topological figure formed with positions of end-effector joints, e.g., positions of joints corresponding to ends of limbs and head of the hierarchical skeletal structure. Therefore, in the embodiment of the present invention, a point cloud formed with the 3D positions of end-effector joints is configured.

FIG. 3 is a view illustrating a virtual marker attaching method in accordance with the embodiment of the present invention.

Referring to FIG. 3, there exist five end-effector joints in a skeleton 300 of specific motion data, and thus a virtual marker 302 is attached to each end-effector joint and an input point cloud can be represented by P=(p1, p2, p3, p4, p5).

If it is assumed that the number of input frames of all motions is F, there are Γ point clouds. Therefore, the scaling unit 106 compares such Γ point clouds with the input point cloud P. At this time, motions having different character sizes have totally different point clouds even if they have exactly the same pose, so they have to be scaled.

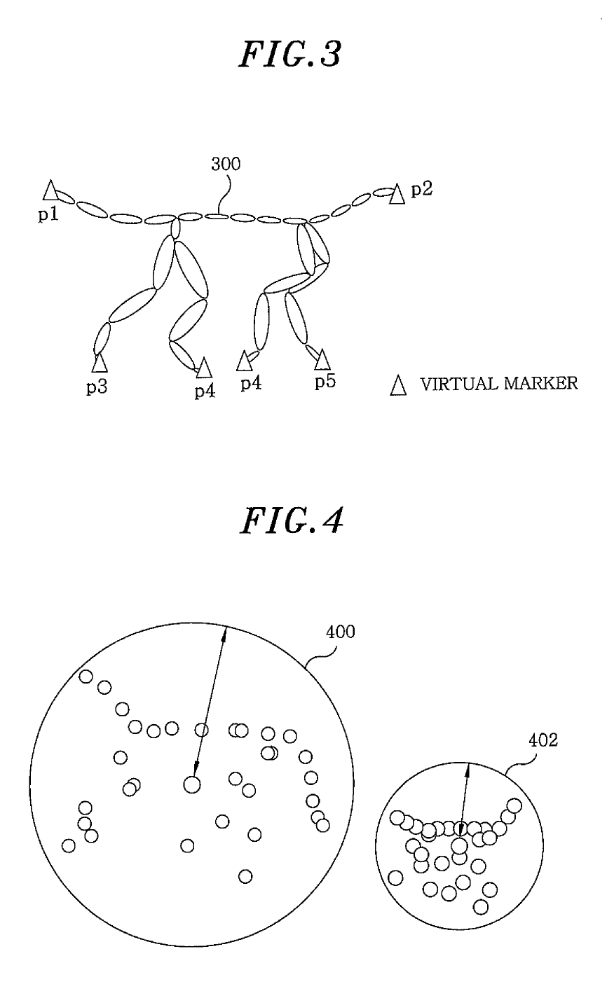

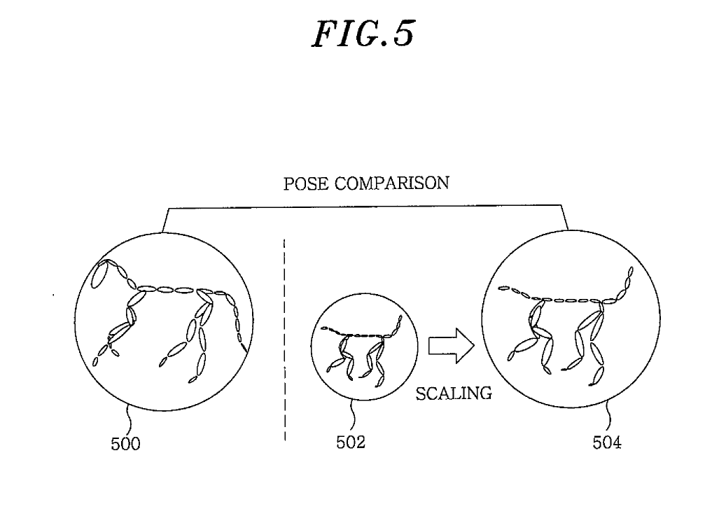

FIG. 4 is a view defining a position of a center point and a character size in accordance with the embodiment of the present invention.

Referring to FIG. 4, the position of the center point, which is the average value of positions of all the points in a point cloud, is calculated, and then a size of each of characters 400 and 402 is defined by a distance between the position of the center point and a position of a farthest point.

That is, the position of the center point is calculated as follows:

$${P}_{center} = \frac{{\sum }_{k = 1}^{m} {P}_{k}}{m} , \qquad Eq . 3$$

wherein P_{center} is the position of the center point, Pₖ is a position of a kₜₕ point among m points in the point cloud.

The character size can be obtained by MAX({square root over ((p_{center}−Pₖ)))}, (0≦k≦m). That is, distances between the center point and other points are calculated, and the farthest distance is determined as the character size.

In other words, even when two motions have an exactly same pose, the point clouds thereof differ depending on character sizes. Therefore, the scaling unit 106 scales the character size to match the character sizes of two characters. To scale the character size, first, the position of the center point is obtained, and then the center position value is subtracted from position values of all the points in the point cloud to perform normalization.

Pₖ′=Pₖ−P_{center} Eq. 4

Next, an average value p_{avg}(i) of the distances between the center point and other points in the point cloud is obtained as follows:

$${p}_{avg} ( i ) = \frac{{\sum }_{k = 1}^{m} \sqrt{{P}_{center} - {P}_{k}^{′}}}{m} \qquad Eq . 5$$

A ratio r of the differences between average values p_{avg}(i) and p_{avg}(j) which are the average value obtained by Eq. 5 is obtained by:

$$r = \frac{{P}_{avg} ( i )}{{P}_{avg} ( j )} , \qquad Eq . 6$$

wherein p_{avg}(i) and p_{avg}(j) are average values of the distances between the center point and other points in the point clouds of two characters being compared.

Then, position values Pₖ″ for new points are calculated by multiplying the distances Pₖ′ between the center point and other points by r as follows:

Pₖ″=Pₖ′·r Eq. 7

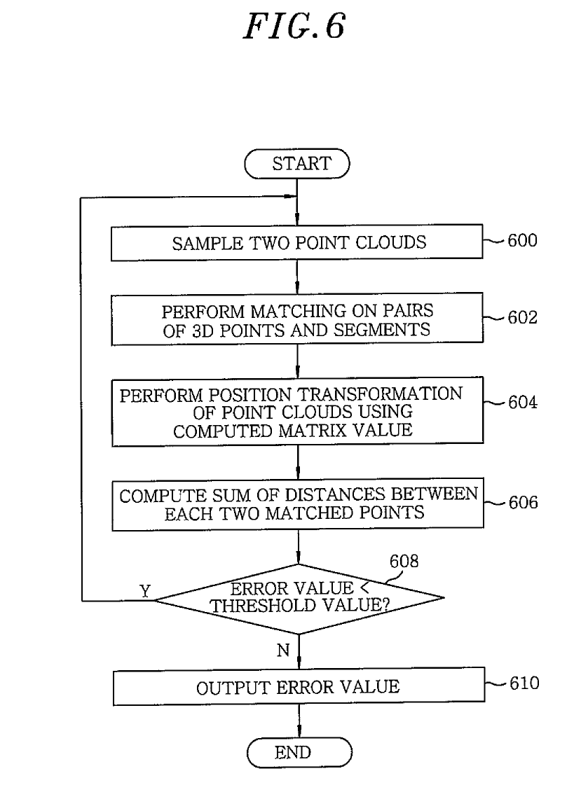

FIG. 5 is a view illustrating a method for scaling the size of a character in accordance with the embodiment of the present invention.

Referring to FIG. 5, the size of a character 502 in the middle is scaled to the size of a right character 504 in order to be matched with the size of a left character 500, the characters 502 and 504 being provided as input, and then the two poses of the characters 502 and 504 are compared with each other.

Finally, the ICP algorithm execution unit 108 uses an ICP algorithm which is a point matching algorithm. The ICP algorithm is used for matching between 3D model data obtained by a computer or a 3D scanner. The ICP algorithm is generally performed in the following steps:

1) Sampling: The same number of points are chosen from two point clouds by sampling;

2) Matching: Pairs of Points having the smallest distance is calculated and matched in the two point sets chosen by sampling;

3) Computing transformation value: A 3D transformation matrix for minimizing the distances between the matched points in the two point sets are found by a least square method;

4) Computing error: The sum (error) of the distances between the two point sets matched by the transformation matrix is obtained; and

5) Comparing values (error<T): It is checked whether the sum of the distances is less or equal to than a preset threshold value, and, if not, the above steps are repeated.

FIG. 6 is a flowchart illustrating an operating procedure of an ICP algorithm in accordance with the embodiment of the present invention.

Referring to FIG. 6, step 600 is a sampling step, in which a point cloud is configured not by using the positions of all the joints, but only by using the joints of the end-effector having the most important effect on representing a pose, thereby improving the speed of the algorithm. In the sampling step, the same number of points is chosen by sampling two cloud points of two input characters configured only by using the joints of the end-effector.

Then, step 602 is a matching step. In an existing matching algorithm, all points of two input point clouds are compared with each other to find a pair having the virtual smallest distance. Further, the exiting matching algorithm does not consider the phases of the entire 3D points but considers the distances alone. However, in the embodiment of the present invention the topological position of a pose is considered. Accordingly, the numbers of the segments of the character to which the 3D points belong need to be input at the time of sampling to take matching into account.

That is, the numbers of the segments to which the 3D points belong, along with the 3D positions of the end-effector, need be input to consider the entire poses when detecting matching points.

Therefore, there are a total of six segments to be used in the embodiment of the present invention. As shown in FIG. 7 which depicts the segments of a character, the segments are divided into HEAD (segment 1), TAIL (segment 6), FRONT_LEFT_LEG (segment 2), FRONT_RIGHT_LEG (segment 3), BACK-LEFT_LEG (segment 4), and BACK_RIGHT_LEG (segment 5).

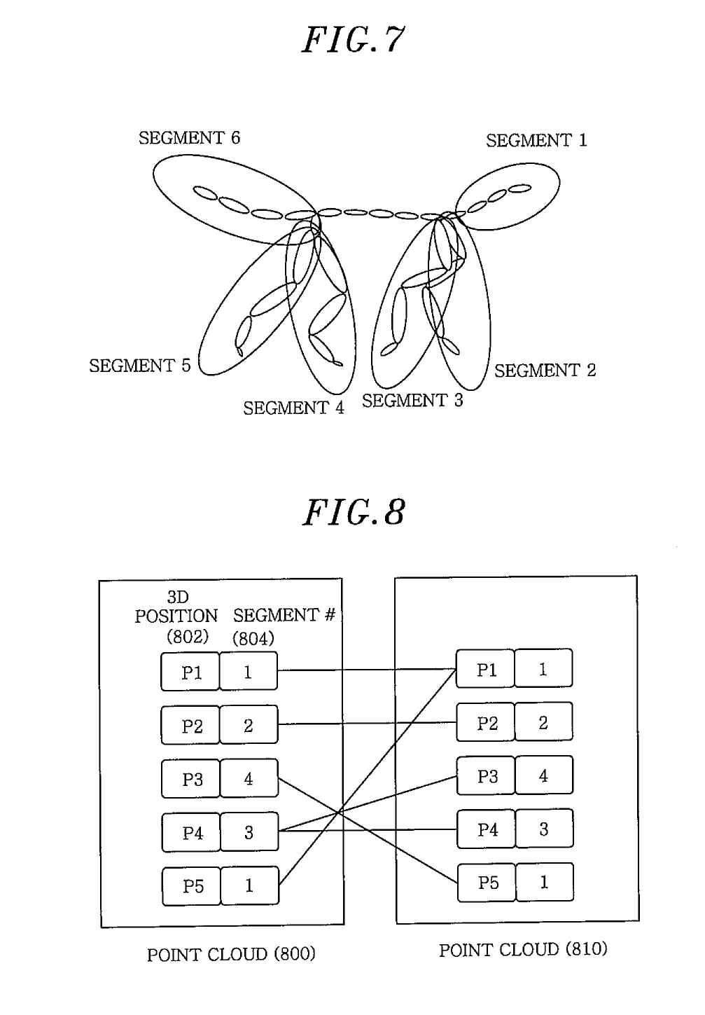

FIG. 8 is a view illustrating an ICP point matching method in accordance with the embodiment of the present invention.

Referring to FIG. 8, if there are two point clouds 800 and 810, each point cloud includes information of 3D points 802 and segments 804 set at the positions of the 3D points 802. Thus, a point having the smallest distance is found for a given pair of a 3D point 802 and a segment 804 for matching therebetween. For example, a distance between P1 in the point cloud 800 and P1 in the point cloud 810 and a distance between P5 in the point could 800 and P1 in the point cloud 810 are compared.

Meanwhile, at step 604, the ICP algorithm execution unit 108 computes a transformation matrix to allow matched two points to have the smallest distance by a least square method. In the embodiment of the present invention, this matrix value is obtained by using a closed-form solution. After obtaining the matrix, the position of one of the point clouds is transformed using this matrix, and the sum (e.g., error value) of the distances between each two matched points is obtained in step 606, and then it is checked whether or not this error value is less or equal to than a preset threshold value in step 608.

If the error value is less or equal to than the threshold value, the process of the present invention returns to step 600 to perform sampling and matching again. However, if the error value is less than or equal to the threshold value, the execution of the ICP algorithm is stopped, and the error value less than this threshold value is output. The output error value finally represents the distance between two poses.

FIG. 2 is a flowchart illustrating an operating procedure of the pose detection apparatus in accordance with the embodiment of the present invention.

Referring to FIG. 2, the motion data input unit 102 receives a plurality of motion data at step 200, and then the virtual marker attaching unit 104 forms a point cloud by attaching virtual markers to the joints of the end-effector at step 202.

Next, at step 204, if a motion having a different character size in the motion data is detected, the scaling unit 106 scales the motion data. At step 206, the ICP algorithm execution unit 108 finds a matching transformation matrix using the ICP algorithm, and determines a frame having the smallest difference from a pose in an original frame to be compared as the most similar pose and outputs it based on the sum of the distances of the virtual markers chosen by sampling the matched two poses.

As described above, the apparatus and method for detecting a pose in motion capture data in accordance with the embodiment of the present invention automatically find a frame having a similar pose by analyzing motion capture data for character animation, and are implemented to find a similar pose even in motion capture data having joints at which the size of a character is different or not exactly the same.

In accordance with the apparatus and method for detecting a pose in motion capture data in accordance with the embodiment of the present invention, by comparing the poses of two characters, a similar pose can be found regardless of character size, number of joints, and rotation of poses.

This is the most basic operation which is used in the process after motion capturing, which can be used to divide a motion into several segments to blend them or to manufacture a high-level data structure, such as a motion graph.

Moreover, the present invention can be used as a database search routine for finding a conceptually similar pose after establishing a database for motion capture data.

While the present invention has been shown and described with respect to the embodiments, it will be understood by those skilled in the art that various changes and modification may be made without departing from the scope of the present invention as defined in the following claims.

What is claimed is:

1. An apparatus for detecting a pose in motion capture data, the apparatus comprising:
a motion data input unit which receives a plurality of motion data of characters;
a virtual marker attaching unit for forming a point cloud by attaching virtual markers to joints of an end-effector of each character in a frame of the motion capture data;
a scaling unit for, when a frame/frames has/have different character size from an a character size of an original frame to be compared is detected, scaling the character size; and
an iterated closest point (ICP) algorithm execution unit for finding a matching transformation matrix between the original frame and each frame of the motion data, of which character size has been scaled, by applying an ICP algorithm, and determining a frame, in which character's pose has the smallest difference from that in the original frame based on a sum of the distances between the virtual markers chosen by sampling the matched two poses.

2. The apparatus of claim 1, wherein the characters are a same kind.

3. The apparatus of claim 1, wherein the virtual marker attaching unit is configured to calculate three-dimensional (3D) global coordinates of the end effector joints for each frame and attach the virtual markers to corresponding positions of the coordinates.

4. The apparatus of claim 1, wherein the scaling unit compares point clouds corresponding to the number of frames of the motion data with a point cloud of the original frame and scales the size of a character having a different point cloud from that of the original frame.

5. The apparatus of claim 1, wherein the scaling unit calculates a center point in the frame/frames which has/have different character size by averaging position values of all points in a point cloud thereof, and then computes a distance between the center point and a farthest point in the point cloud to scale the character size by the corresponding distance.

6. The apparatus of claim 1, wherein the ICP algorithm execution unit chooses same numbers of points to form two point sets by sampling two point clouds configured only by using the joints of the end-effector in the character, calculates pairs of points having the smallest distances each other in the two point clouds to thereby match the two point sets chosen by sampling, computes a 3D transformation matrix for minimizing the distance between the matched two point sets, obtains an error value, which is the sum of the distances of the two point sets matched by the 3D transformation matrix, and compares the error value with a preset threshold value to determine a similar pose.

7. The apparatus of claim 6, wherein the ICP algorithm execution unit computes the 3D transformation matrix using a closed-form solution, transforms the position of one of the point clouds by using the computed transformation matrix, and then obtains the sum of the distances between pairs of points in matched point sets.

8. The apparatus of claim 6, wherein the ICP algorithm execution unit uses information of an n-number of segments forming each of characters by considering the distance and topological position of the 3D points at the time of matching.

9. The apparatus of claim 8, wherein the information of the n-number of the segments is input into each of the 3D points of the point clouds at the time of sampling.

10. The apparatus of claim 6, wherein the error value becomes distance information between two poses.

11. A method for detecting a pose in motion capture data, the method comprising:
receiving a plurality of motion data of characters;
forming a point cloud by attaching virtual markers to joints of an end-effector of each character in a frame of the motion capture data and;
finding a matching transformation matrix between the original frame and each frame of the motion data, of which character size has been scaled, by applying an iterated closest point (ICP) algorithm, and determining a frame, in which character size having the smallest difference from an the original frame based on a sum of the distances between the virtual markers chosen by sampling the matched two poses.

12. The method of claim 11, wherein the characters are a same kind.

13. The method of claim 11, wherein in said attaching virtual markers, 3D global coordinates of the end effector joints are calculated for each frame and the virtual markers are attached to corresponding positions of the coordinates.

14. The method of claim 11, further comprising:
scaling the character size when a frame/frames has/have different character size from an a character size of an original frame to be compared is detected.

15. The method of claim 14, wherein said scaling the motion data compares point clouds corresponding to the number of frames of the motion data with a point cloud of the original frame and scales the size of a character having a different point cloud from that of the original frame.

16. The method of claim 14, wherein said scaling the motion data includes:
calculating a center point in the frame/frames which has/have different character size by averaging position values of all the points in a point cloud thereof; and
computing a distance between the center point and a farthest point in the point cloud to scale the character size by the corresponding distance.

17. The method of claim 11, wherein said determining a frame includes:
choosing same numbers of points to form two point sets by sampling two point clouds configured only by using the joints of the end-effector in the character;
calculating pairs of points having the smallest distance each other in two point clouds to thereby match the two point sets chosen by sampling;
computing a 3D transformation matrix for minimizing the distance between the matched two point sets;
obtaining an error value, which is the sum of the distances of the two point sets matched by the 3D transformation matrix; and
comparing the error value with a preset threshold value to extract a similar pose.

18. The method of claim 17, wherein said determining a frame uses information of an n-number of segments forming each of characters by considering the distance and topological position of the 3D points at the time of matching.

19. The method of claim 18, wherein the information of the n-number of segments is input into each of the 3D points of the point clouds at the time of sampling.

20. The method of claim 17, wherein the error value becomes finally distance information between two poses.
